(19) United States
(12) Patent Application Publication
(10) Pub. No.: US 2006/0206743 A1
(43) Pub. Date: Sep. 14, 2006

(54) COMPUTER SYSTEM HAVING A CLOCK CONTROLLER FOR CONTROLLING AN OPERATING CLOCK INPUTTED INTO A NO-WAIT-STATE MICROPROCESSOR AND METHOD THEREOF

(76) Inventors: Hui-Huang Chang, Hsin-Chu Hsien (TW); Chien-Cheng Chiang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/906,841

(22) Filed: Mar. 8, 2005

(51) Int. Cl. G06F 1/04

(52) U.S. Cl. 713/600

(57) ABSTRACT

The present invention discloses a computer system with a clock controller for controlling an operating clock inputted into a no-wait-state microprocessor. The computer system includes a data cache memory and a system memory. The clock controller blocks the operating clock from driving the no-wait-state microprocessor if data requested by the microprocessor is not stored in the cache and allows the operating clock to drive the microprocessor if data requested by the microprocessor is stored in the cache.

### BACKGROUND OF THE INVENTION

1. Field of the Invention

The present invention relates to a computer system, and more particularly, to a computer system having a clock controller to control an operating clock inputted into a no-wait-state microprocessor and a method thereof.

2. Description of the Prior Art

A modern day house will contain numerous microprocessors of simplified architecture to perform specific tasks. These simplified microprocessors are sometimes called micro-controllers. For instance, many computer peripheral devices, such as scanners, printers and optical disc drives, have micro-controllers inside to make these peripheral devices operate as desired. In addition, micro-controllers are commonly embedded inside consumer electronics devices such as microwaves, TVs, VCRs, cellphones etc.

A typical micro-controller, such as an Intel 8051, consists of a CPU core, a 4 k-byte Read Only Memory (ROM), a 128-byte Random Access Memory (RAM), a plurality of timers, a plurality of I/O ports, and a bus controller for controlling data transfer through the I/O ports. The bus controller generates a strobe signal WR to enable an external data memory to write data into the micro-controller, generates a strobe signal RD to enable an external data memory to read data from the micro-controller, and generates a strobe signal PSEN to enable an external program memory to write programs into the micro-controller. That is, the 8051 supports access of external data memory and program memory. As known to those skilled in this art, the 8051 microprocessor accesses external data memory and program memory every 4 or 12 clock cycles, which limits the data transfer rate between the external memory and the microprocessor. If the external data memory and program memory are not synchronized with the microprocessor, the microprocessor is unable to communicate with the external data memory and program memory, resulting in unexpected data loss. Therefore, a high-speed and low-cost external memory, such as a synchronous dynamic random access memory (SDRAM), cannot be used in conjunction with the 8051 microprocessor. Sometimes, a high-cost static random access memory (SRAM) is utilized to meet the above data transfer requirement.

If a high-speed and low-cost memory, ex: the SDRAM, is used as an external memory, in order to solve the above synchronization problem, an advanced microprocessor must be applied. The speed of operation of the SDRAM is several clock cycles slower than the advanced microprocessor so in order for the two components to synchronize, the advanced microprocessor has to add wait states to its operation. These wait states are dummy clock cycles, allowing the SDRAM to ‘catch up’ with the advanced microprocessor. In other words, a system clock keeps inputting the operating clock into the advanced microprocessor, but the advanced microprocessor is idle due to the enabled wait state(s). The disadvantage is that these advanced microprocessors are expensive. Additionally, every wait state is a wasted clock cycle where the CPU is not doing anything.

### SUMMARY OF INVENTION

It is therefore one of the objectives of the claimed invention to provide a computer system having a clock controller to control an operating clock inputted into a no-wait-state microprocessor and a method thereof, to solve the above mentioned problems.

It is therefore one of the objectives of the claimed invention to provide a computer system having a clock controller. The speed of operation of the computer system is faster, and the action of pausing operation of the microprocessor while data is searched for in the main memory allows power to be saved.

Briefly described, the invention discloses a computer system. The computer system comprises a microprocessor driven by an operating clock; a first storage device for storing data; a clock controller coupled between the microprocessor and the first storage device, for blocking the operating clock from driving the microprocessor if a predetermined data requested by the microprocessor is not stored in the first storage device and for allowing the operating clock to drive the microprocessor if the predetermined data requested by the microprocessor is stored in the first storage device; a second storage device for storing the predetermined data; and a data accessing controller coupled between the first storage device and the second storage device, for transferring the predetermined data from the second storage device into the first storage device if the predetermined data requested by the microprocessor is not stored in the first storage device.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a computer system according to an embodiment of the present invention.

FIG. 2 is a flowchart detailing the operation of the computer system shown in FIG. 1

### DETAILED DESCRIPTION

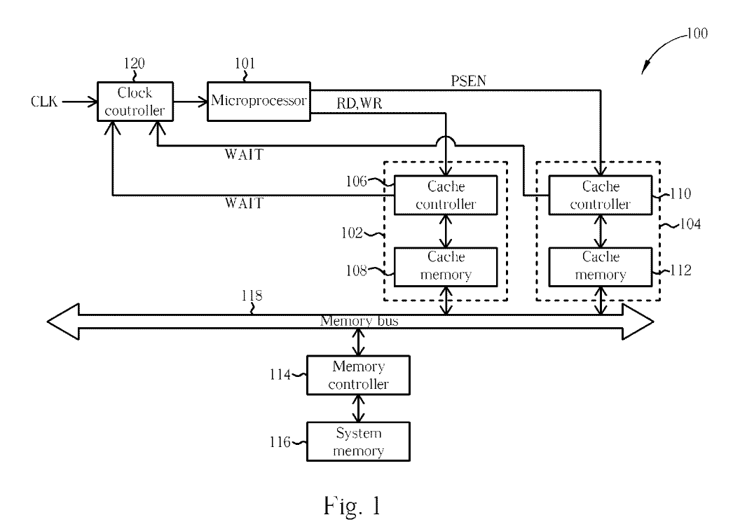

Please refer to FIG. 1. FIG. 1 is a diagram of a computer system 100 according to an embodiment of the present invention. The computer system comprises a no-wait-state microprocessor 101, electrically coupled to a data cache system 102 and a program cache system 104 through I/O ports (not shown) thereof. As mentioned above, the microprocessor 101 issues a strobe signal PSEN to control data transfer between the microprocessor 101 and the program cache system 104, and issues strobe signals RD and WR to control data transfer between the microprocessor 101 and the data cache system 102.

As shown in FIG. 1, each of the cache systems 102, 104 includes a cache controller 106, 110 respectively and a cache memory (volatile memory) 108, 112 respectively. In addition, the data cache system 102 and the program cache system 104 are further coupled to a system memory 116 through a memory controller 114 and a memory bus 118. Since the operation of the above mentioned components are well known to those skilled in this art, further description is omitted here for the sake of brevity.

As shown in FIG. 1, there is a clock controller 120 coupled to the microprocessor 101 and the cache controllers 106, 110. The clock controller 120 is used to control the delivery of the operating clock CLK required by the microprocessor 101. That is, the microprocessor 101 is triggered by the operating clock CLK to operate normally. Please note that in this embodiment, the CPU operating clock can operate at the same speed as the data cache system. The clock controller 120 blocks the operating clock CLK from entering the microprocessor 101 only when receiving a notification signal WAIT outputted from the cache controllers 106, 110. The operation of the clock controller 120 is detailed as follows.

In an initial condition, the clock controller 120 allows the operating clock CLK to drive the microprocessor 101. When the microprocessor needs to read a required data from an external memory (i.e., the data cache system 102), it first sends a strobe signal RD to the cache controller 106 in order to obtain the required data. If the required data exists in the cache memory 108 and is valid, a ‘cache hit’ occurs and the cache controller 106 does not trigger the notification signal WAIT. The microprocessor 101, therefore, keeps working to retrieve the required data from the cache memory 108.

If, however, the data does not exist in the cache memory 108, a ‘cache miss’ occurs. In this case, the relevant data must be searched for in the system memory 116. Please note that the system memory 116 could be any storage device such as an SDRAM or a Flash memory. When the cache controller 106 acknowledges the ‘cache miss’, it first sends a notification signal WAIT to the clock controller 120, informing it that the required data is not present in the cache memory 108. This notification signal WAIT enables the clock controller 120 to block the operating clock CLK from driving the microprocessor 101, causing the operation of the microprocessor 101 to be paused. Meanwhile, the cache controller 106 asks the memory controller 114 for the required data not present in the cache memory 108. After the memory controller 114 transmits the required data from the system memory 116 to the cache memory 108, the memory controller 114 resets the notification signal WAIT, allowing the operating clock CLK to drive the microprocessor 101 once more. Because the required data has been stored in the cache memory 108, the microprocessor 101 can successively obtain the required data after its operation is resumed. The program cache system 104 has the same functionality and operation as the data cache system 102. Therefore, further description is omitted for brevity.

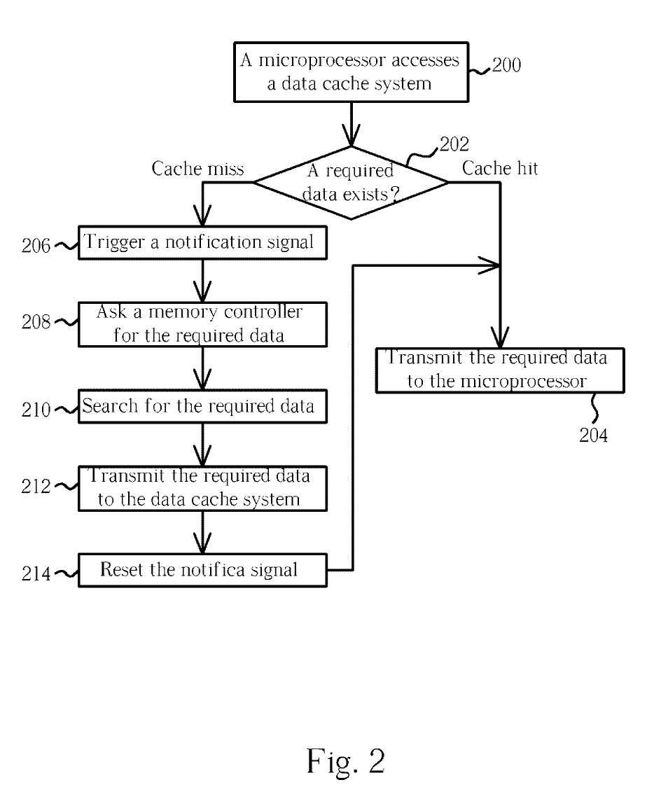

Please refer to FIG. 2. FIG. 2 is a flowchart detailing the operation of the computer system 100 shown in FIG. 1. Take the microprocessor 101 accessing the data cache system 102 for example.

Step 200: The microprocessor 101 outputs a strobe signal to the data cache system 102 for accessing a required data.

Step 202: The cache controller 106 detects if the required data is stored in the cache memory 108. If ‘cache hit’ occurs, go to step 204.

Step 206: The cache controller 106 triggers a notification signal WAIT to enable the clock controller 120 to block the operating clock CLK from driving the microprocessor 101.

Step 208: The cache controller 106 asks the memory controller 114 for the required data.

Step 210: The memory controller 114 searches for the required data in the system memory 116.

Step 212: The memory controller 114 transmits the required data to the data cache system 102 via the memory bus 118.

Step 214: The cache controller 106 resets the notification signal WAIT, allowing the operating clock CLK to drive the microprocessor 101 once more.

Step 204: The data cache system 108 transmits the required data to the microprocessor 101.

According to the present invention, the operating speed of the no-wait-state microprocessor, such as the Intel 8051 microprocessor, can be greatly improved owing to the claimed clock controller. In addition, the operation of the external memory is not required to be synchronized with the operation of the no-wait-state microprocessor. In conclusion, the present invention has several advantages including increased efficiency, low costs and higher performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system comprising:
a microprocessor driven by an operating clock;
a first storage device for storing data;
a clock controller coupled between the microprocessor and the first storage device, for blocking the operating clock from driving the microprocessor if a predetermined data requested by the microprocessor is not stored in the first storage device and for allowing the operating clock to drive the microprocessor if the predetermined data requested by the microprocessor is stored in the first storage device;
a second storage device for storing the predetermined data; and
a data accessing controller coupled between the first storage device and the second storage device, for transferring the predetermined data from the second storage device into the first storage device if the predetermined data is not stored in the first storage device.

2. The computer system of claim 1, wherein the first storage device comprises:
a data detector for detecting if the predetermined data is stored in the first storage device and for informing the clock controller of a detection result.

3. The computer system of claim 2 wherein the data detector triggers a notification signal if the predetermined data is not stored in the first storage device, and then resets the notification signal if the predetermined data has been transferred from the second storage device into the first storage device.

4. The computer system of claim 2 wherein the first storage device is a cache memory, the second storage device is a system memory of the computer system, the data detector is a cache controller of the cache memory, and the data accessing controller is a memory controller of the system memory.

5. The computer system of claim 1 wherein the first storage device is a volatile memory.

6. The computer system of claim 5 wherein the volatile memory is a cache memory, the second storage device is a system memory of the computer system, and the data accessing controller is a memory controller of the system memory.

7. The computer system of claim 1 wherein the microprocessor is a no-wait-state microprocessor.

8. The computer system of claim 7 wherein the microprocessor is an 8051-based microprocessor.

9. A method for operating a computer system comprising:
blocking an operating clock from driving a microprocessor if a predetermined data requested by the microprocessor is not stored in a first storage device, and allowing the operating clock to drive the microprocessor if the predetermined data requested by the microprocessor is stored in the first storage device; and
transferring the predetermined data from a second storage device into the first storage device if the predetermined data requested by the microprocessor is not stored in the first storage device.

10. The method of claim 9 wherein the first storage device is a volatile memory.

11. The method of claim 10 wherein the volatile memory is a cache memory, and the second storage device is a system memory of the computer system.

12. The method of claim 9 wherein the microprocessor is a no-wait-state microprocessor.

13. The method of claim 12 wherein the microprocessor is an 8051-based microprocessor.

14. The method of claim 9, further comprising:
triggering a notification signal if the predetermined data is not stored in the first storage device; and
resetting the notification signal if the predetermined data has been transferred from the second storage device into the first storage device.

15. A computer system comprising:
a no-wait-state microprocessor driven by an operating clock;
a cache memory for storing data;
a clock controller coupled between the no-wait-state microprocessor and the cache memory, for blocking the operating clock from driving the no-wait-state microprocessor if a predetermined data requested by the no-wait-state microprocessor is not stored in the cache memory and for allowing the operating clock to drive the no-wait-state microprocessor if the predetermined data requested by the no-wait-state microprocessor is stored in the cache memory;
a system memory for storing the predetermined data; and
a memory controller coupled between the cache memory and the system memory, for transferring the predetermined data from the system memory into the first storage device if the predetermined data requested by the no-wait-state microprocessor is not stored in the cache memory.

16. The computer system of claim 15 further comprising:
a cache controller coupled between the clock controller and the cache memory, for detecting if the predetermined data is stored in the cache memory and for informing the clock controller of a detection result.
